(19) United States
(12) Patent Application Publication
(10) Pub. No.: US 2012/0032035 A1
(43) Pub. Date: Feb. 9, 2012

(54) APPARATUS FOR SUPPORTING UTILITY LINES

(76) Inventors: Bradford J. Burrows, West Olive, MI (US); Ryan D. Barman, Holland, MI (US); Robert C. Hansen, Muskegon, MI (US); James F. McKnight, Holland, MI (US)

(21) Appl. No.: 13/196,034

(22) Filed: Aug. 2, 2011

Related U.S. Application Data
(60) Provisional application No. 61/370,611, filed on Aug. 4, 2010.

(51) Int. Cl. F16L 3/08

(52) U.S. Cl. 248/70

(57) ABSTRACT

An apparatus for supporting utility lines extending between a vehicle and a trailer comprises an elastically deformable rod having a first end and a second end, an attachment feature for attaching utility lines to the apparatus, and a mounting base for mounting the apparatus to a surface. The attachment feature is disposed or configured to be disposed proximate the first end of the rod. The mounting base is disposed or configured to be disposed at the second end of the rod. In another embodiment, the apparatus comprises a first portion comprising a shaft having a first and a second end, a second portion integral with the first portion comprising a spring, an attachment feature for attaching utility lines to the apparatus configured to be disposed proximate the first end of the shaft, and a mounting feature associated with the second portion for mounting the apparatus to a surface.

### CROSS REFERENCE TO RELATED APPLICATIONS

This application claims the benefit of U.S. Provisional Application Ser. No. 61/370,611 entitled “Post for Supporting Electrical and Air Lines,” filed on Aug. 4, 2010, now pending, and hereby incorporated by reference in its entirety.

### FIELD OF THE INVENTION

This disclosure relates to apparatus for supporting utility lines. More particularly, this disclosure relates to an apparatus for supporting utility lines, such as, for example, electrical cables and air hoses, extending between a vehicle, such as, for example, a truck, and a trailer.

### BACKGROUND OF THE INVENTION

It is well known that in certain instances wherein a vehicle, such as, for example, a truck, is attached to and pulls a trailer, utility lines must be connected between the truck and the trailer for operating brakes, lights, and other equipment of or on the trailer. These utility lines include, for example, electrical cables and air hoses or tubes.

In such instances, the utility lines must be of a sufficient length to accommodate different orientations and the change of the attitude of the truck with respect to the trailer. For example, when the truck and trailer are aligned (e.g., in a straight line), the distance between a connection point for the utility lines on the truck and a connection point for the utility lines on the trailer may be significantly shorter than the distance between the same two connection points when the truck is disposed at an angle relative to the trailer (e.g., when the truck is turning, for example, and the trailer pivots). Accordingly, the utility lines must be sufficiently long to allow for the longest distance between the respective connection points without the utility lines being pulled out of the connection points. As a result, when the truck and the trailer are aligned, there is significant amount of slack in the utility lines that render them susceptible to being pinched off (i.e., pinched such that the flow of air therein, for example, is inhibited) or damaged, such as, for example, the lines being severed as a result of getting caught between moving components, holes (and thus leaks) being created in the lines caused by repeated abrasion of the lines against other components, etc.

Various types of devices have been employed in an effort to lessen the risk of disconnection of, or damage to, the lines during operation of the truck and trailer, as well as the truck without the trailer (i.e., when the truck operates without a trailer attached thereto). One such device is commonly referred to in the art as a “pogo stick” or “pogo.” A pogo is a mechanism that is placed approximately mid-way between the truck and the trailer, and is configured to support the utility lines.

Generally speaking, a pogo comprises a metal post or rod to which the utility lines are attached, and a metal base including a spring that is mounted to a surface on the truck. When the truck is aligned with the trailer, the post remains in an upright position and supports the utility lines to prevent them from falling into a position where they may be damaged. However, when the truck turns relative to the trailer such that truck and trailer are at an angle to each other, sideways forces or loads are applied to the utility lines and the pogo. The pogo deflects or bends while the force or load is applied, thereby both supporting the utility lines and preventing the tensioning thereof, and thus, also preventing both the disconnection of the utility lines and the falling of the utility lines into an undesirable position. As the angle between the truck and trailer is reduced (i.e., the truck turns in the opposite direction) the force or load is gradually removed from the utility lines and the post, and the post gradually returns to its original, upright position when the truck and trailer are close to alignment and the force or load is sufficiently lessened or removed.

Conventional devices such as that described above are not without their draw backs, however. For example, many conventional pogos are constructed of multiple pieces (e.g., a post, a spring, a cylinder for housing the spring, a base member, etc.). As a result, the pogos are prone to early life cycle failure and are considerably expensive for the purpose they serve and function they perform. Additionally, the spring of the pogo may also have a shortened life cycle due to yielding/failure. Further, the components of the pogos are typically formed of, or plated with, a metallic material, thereby rendering the device prone to corrosion. Yet still further, the performance of conventional pogos can vary by the direction of loading applied to the post due to the nature of the spring being mounted internally to the device (i.e., the spring is mounted within a cylinder).

Therefore, there is a need for an apparatus for supporting one or more utility lines extending between a vehicle and a trailer that will minimize and/or eliminate one or more of the above-identified deficiencies.

### SUMMARY OF THE INVENTION

The present invention is directed to an apparatus for supporting one or more utility lines extending between a vehicle and a trailer.

In an exemplary embodiment the apparatus comprises an elastically deformable rod having a first end and a second end. The apparatus further comprises an attachment feature configured to attach at least one utility line to the apparatus. In an exemplary embodiment, the attachment feature is disposed proximate the first end of the rod. In another exemplary embodiment, the attachment feature is configured to be coupled with the rod proximate the first end thereof. The apparatus still further comprises a mounting base configured for mounting the apparatus to a surface. In an exemplary embodiment, the mounting base is disposed at the second end of the rod. In another exemplary embodiment, the mounting base is configured to be coupled with the rod at the second end thereof.

In another exemplary embodiment, the apparatus comprises a first portion comprising an elongate shaft having a first end and a second end. In this embodiment, the apparatus further comprises a second portion that is integral with the first portion and that comprises a spring. The apparatus further includes an attachment feature configured to be disposed proximate the first end of the shaft, and to attach at least one utility line to the apparatus. The apparatus still further comprises a mounting feature associated with the second portion of the apparatus configured for mounting the apparatus to a surface.

Further features and advantages of the present invention, including the constituent components thereof, will become more apparent to those skilled in the art after a review of the invention as it is shown in the accompanying drawings and detailed description.

### BRIEF DESCRIPTION OF THE DRAWINGS

FIG. 1 is a diagrammatic view of an exemplary embodiment of an apparatus for supporting one or more utility lines in use with a truck and trailer.

FIG. 2 is an isometric view of an exemplary embodiment of an apparatus for supporting one or more utility lines extending between a vehicle and a trailer.

FIG. 3 is an exploded isometric view of the apparatus illustrated in FIG. 2.

FIG. 4 is an isometric view of alternate exemplary embodiment of the base portion of the apparatus illustrated in FIGS. 2 and 3.

FIG. 5 is a front view of the base portion of the apparatus illustrated in FIGS. 2 and 3 mounted to a mounting surface.

FIG. 6 is an isometric view of another exemplary embodiment of an apparatus for supporting one or more utility lines extending between a vehicle and a trailer.

FIG. 7 is a front view of an exemplary embodiment of an attachment feature of the apparatus illustrated in FIG. 6.

FIG. 8 is a side view of the upper portion of the apparatus illustrated in FIG. 6 including the attachment feature illustrated in FIG. 7 including a utility line accommodating apparatus/accessory attached thereto.

FIGS. 9A is an isometric view of an exemplary embodiment of a mounting base of the apparatus illustrated in FIG. 6.

FIG. 9B is a cross-sectional view of the mounting base illustrated in FIG. 9A taken along the lines 9B-9B in FIG. 9A.

FIG. 10A is an isometric view of another exemplary embodiment of the mounting base of the apparatus illustrated in FIG. 6.

FIG. 10B is a partial cross-sectional view of the mounting base illustrated in FIG. 10A taken along the lines 10B-10B in FIG. 10A.

FIG. 11 is an isometric view of yet another embodiment of an apparatus for supporting one or more utility lines extending between a vehicle and a trailer.

### DETAILED DESCRIPTION OF PREFERRED EMBODIMENTS

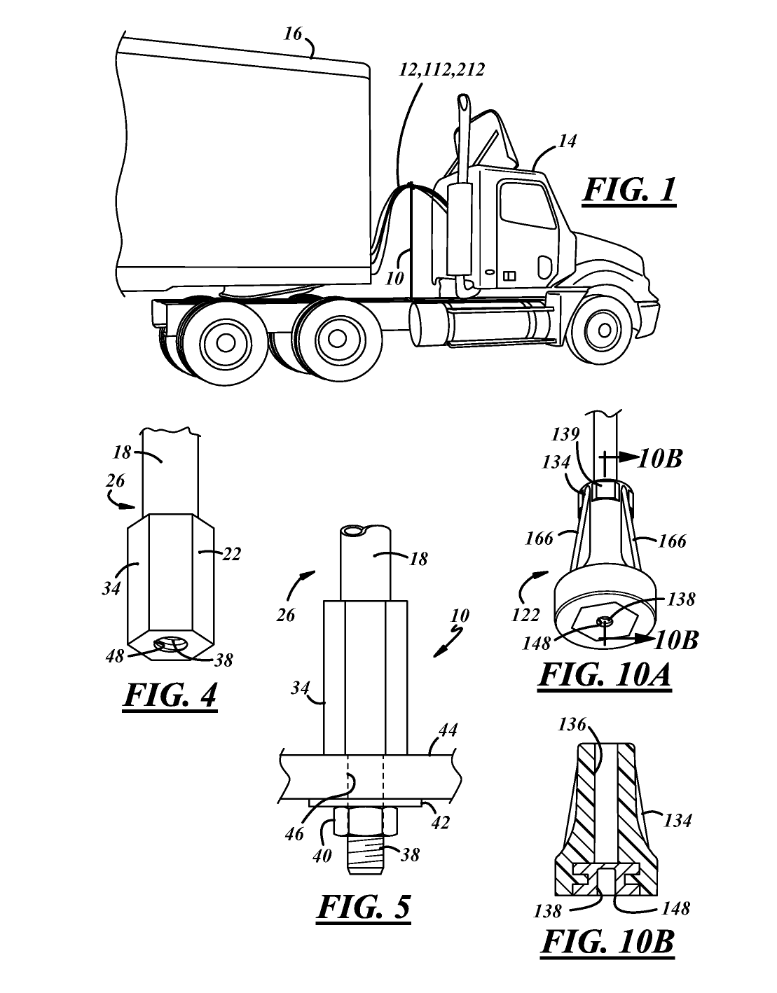

Referring now to the drawings wherein like reference numerals are used to identify identical components in the various views, FIG. 1 illustrates an exemplary embodiment of an apparatus 10 for supporting one or more utility lines 12 extending and draping between a vehicle 14, such as, for example and without limitation, a truck, and a trailer 16. The utility lines 12 may include, for example and without limitation, cables, tubes, hydraulic lines, hoses, and other like flexible components that are used to couple power units disposed in or on the truck 14 (such as, for example, electrical power sources, air sources, etc.) to the trailer 16.

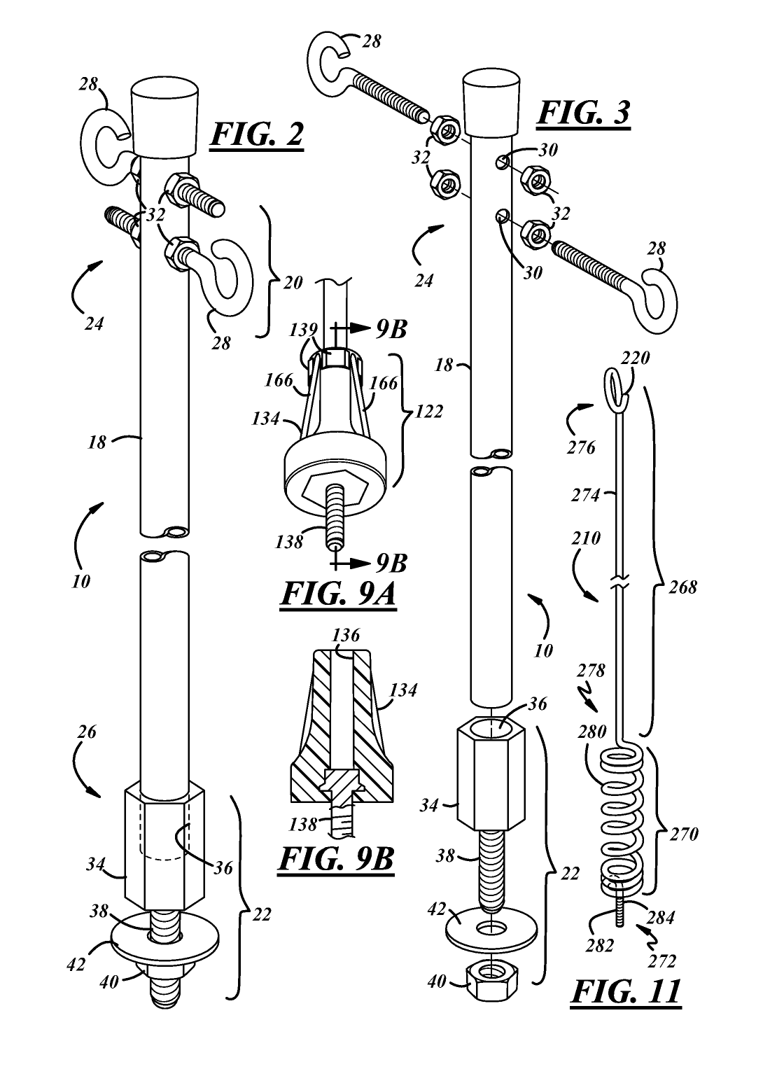

FIGS. 2 and 3 illustrate an exemplary embodiment of the apparatus 10. In the illustrated embodiment, the apparatus 10 comprises a rod 18, an attachment feature 20, and a mounting base 22.

The rod 18 has a first end 24 and a second end 26, and is constructed of a material that renders the rod 18 elastically deformable (i.e., both flexible and resilient). More particularly, the rod 18 is constructed such that when a sufficient force or load (e.g., a lateral force or a force having a lateral component) is applied at or near the first end 24 of the rod 18 by utility lines 12 that, as will be described below, are attached to the rod 18 at or near the first end 24 thereof, the rod 18 will flex/deflect or deform, and then return back to its original state when the force is reduced or removed. For example, in one embodiment provided for exemplary purposes only, the rod 18 may begin to flex or deflect upon the application of approximately 10 lbs. of force by the utility lines 12 at or near the first end 24 thereof, and is configured to withstand approximately 35-40 lbs. of force applied thereto. It will be appreciated, however, that the above described embodiment was provided for exemplary purposes only and is not meant to be limiting in nature. Rather, the rod 18 may be constructed such that the amount of force required to flex/deflect or deform the rod 18, and the amount of force the rod 18 may withstand without yielding, may be greater than or less than that described above. Accordingly, these embodiments of the rod 18 remain within the spirit and scope of the present disclosure.

In an exemplary embodiment, the rod 18 is constructed of, and therefore comprises, a polymeric material, such as, for example and without limitation, a thermoset polyester. It will be appreciated, however, that in other exemplary embodiments, polymeric materials other than a thermoset polyester may be used. Further, in another exemplary embodiment, the rod 18 is constructed of a composite material, such as, for example and without limitation, a thermoset polyester and glass strand composite. It will be appreciated, however, that any number of composites known in the art that will render the rod 18 sufficiently elastically deformable may be used, and therefore, remain within the spirit and scope of the present disclosure. In an exemplary embodiment, all or a portion of the rod 18 may also comprise a photoluminescent material so as to render the rod 18 capable of glowing in the dark. This material may comprise materials that are known in the art, such as, for example and without limitation, glow-in-the-dark concentrates and colorants, that are operative to cause the rod 18 (or portions thereof) to glow-in-dark and to do so in various colors and shades thereof.

In the embodiment illustrated in FIGS. 2 and 3, the rod 18 has a circular cross-section. However, in other exemplary embodiments, the rod 18 may have a cross-sectional shape other than circular, such as, for example and without limitation oval, square, rectangular, triangular, or other polygonal shapes. Further, the rod 18 may have a constant diameter from the first end 24 to the second end 26 (e.g., on the order of 0.5 inches or 1.27 cm), or alternatively, the diameter may vary from the first end 24 to the second end 26. Yet still further, the rod 18 may have a solid or, in another exemplary embodiment, a hollow construction.

As briefly described above, and as illustrated in FIGS. 2 and 3, the apparatus 10 comprises an attachment feature 20. The attachment feature 20 is configured to attach one or more utility lines 12 to the apparatus 10. The attachment feature 20 is disposed, or configured to be disposed, proximate the first end 24 of the rod 18. More particularly, in an exemplary embodiment, the attachment feature 20 is coupled with, or configured to be coupled with, the rod 18 at or near the first end 24 thereof. In such an embodiment, the attachment feature 20 may be coupled to the rod 18 using any number of techniques known in the art, such as, for example and without limitation, using adhesives, mechanical fasteners, drilling, insert molding, heat treating processes, and the like. Alternatively, rather than coupling the attachment feature 20 with the rod 18, the attachment member 20 may be integral with the rod 18 at or near the first end 24 thereof.

The attachment feature 20 may take on any number of forms. For example, in the embodiment illustrated in FIGS. 2 and 3, the attachment feature 20 comprises one or more eye-bolts 28 that are configured to be coupled with the rod 18, and further configured to attach one or more utility lines 12 to the apparatus 10. More particularly, in the illustrated embodiment, the rod 18 has one or more holes 30 (best shown in FIG. 3) through which a portion of a respective eye-bolt 28 may be inserted and passed through. A nut 32, or a nut and a washer, may be then mated with a threaded portion of the eye-bolt 28 to hold the eye bolt in place. The eyelet or ring portion of each eye-bolt 28 may be adapted accommodate one or more utility lines 12 therein, or may be adapted to accommodate additional apparatus/accessories, such as, for example, one or more clips, rings, loops, clamps, hooks, or the like, that are, in turn, configured and adapted to accommodate one or more utility lines 12.

While the description above has been with respect to the attachment feature 20 comprising one or more eye-bolts, those having ordinary skill in the art will appreciate that in other exemplary embodiments, the attachment feature 20 may comprise apparatus other than eye-bolts, such as, for example and without limitation, hooks, rings, clips, loops, clamps, and other like apparatus and components that are configured to be coupled to the rod 18 in the same or similar manner described above, and to support one or more utility lines 12, each of which remain within the spirit and scope of the present disclosure. Accordingly, the embodiment wherein the attachment feature 20 comprises one or more eye-bolts 28 is provided for exemplary purposes only and is not meant to be limiting in nature. Similarly, while the description above has been limited to an embodiment wherein the attachment feature 20 is bolted to the rod 18, those having ordinary skill in the art will appreciated that in other exemplary embodiments, the attachment feature 20 may be coupled to the rod 18 using other known techniques, such as, for example and without limitation, using adhesives, heating treating processes, clamping techniques, and other like coupling/affixation techniques, each of which remains within the spirit and scope of the present disclosure. Accordingly, the embodiment wherein the attachment feature 20 is bolted to the rod 18 is provided for exemplary purposes only, and is not meant to be limiting in nature.

As briefly described above, and with reference to FIGS. 2-4, the apparatus 10 further comprises a mounting base 22. The mounting base 22 is configured for mounting the apparatus 10 to a surface, such as, for example and without limitation, an appropriate mounting surface on a truck or a trailer (See FIG. 1). The mounting base 22 is disposed, or configured to be disposed, at the second end 26 of the rod 18. More particularly, in an exemplary embodiment, the mounting base 22 is coupled with, or configured to be coupled with, the second end 26 of the rod 18. The mounting base 22 may be coupled with the rod 18 using any number of techniques known in the art, some of which will be described in greater detail below. Alternatively, rather than coupling the mounting base 22 with the rod 18, the mounting base 22 may be integral with the rod 18 at the second end 26 thereof.

In an exemplary embodiment, the mounting base 22 has an elongate body 34. As illustrated in FIGS. 2 and 3, the body 34 comprises a bore 36 therein sized and configured to receive the second end 26 of the rod 18. Accordingly, when assembled, the second end 26 of the rod 18 is disposed within the bore 36 (best shown in FIG. 2). In an exemplary embodiment, an adhesive is applied to the inner surface of the bore 36 and/or the outer surface of the second end 26 of the rod 18 so as to allow the rod 18 to be affixed to or coupled with the mounting base 22.

In another exemplary embodiment, the bore 36 may comprise a threaded bore (not shown), and the rod 18 may include a complementary threaded portion (e.g., a male threaded portion) (not shown). In such an embodiment, the mounting base 22 may be threaded onto the rod 18. An adhesive may also be applied to one or both of the outer surface of the threaded portion of the rod and the inner surface of the bore to further secure the connection between the components.

In still another exemplary embodiment, the mounting base 22 may include a male threaded portion (not shown), and the second end 26 of the rod 18 may include a female threaded portion (not shown) therein. In such an embodiment, the mounting base 22 may be threaded into the female threaded portion of the rod 18. An adhesive may also be applied to one or both of the outer surface of the threaded portion of the rod and the inner surface of the bore to further secure the connection between the components.

In yet still another exemplary embodiment, and depending on the material of which the mounting base 22 is constructed, the mounting base 22 may be molded onto the second end 26 of the rod 18 in the manner described in greater detail below with respect to the coupling of the mounting base 122 with the rod 118, and thus, the description below applies here with equal weight.

Accordingly, the mounting base 22 may be coupled with the rod 18 using any number of techniques known in the art, all of which remain within the spirit and scope of the present invention.

In an exemplary embodiment, the body 34 is formed of a metallic material, such as, for example and without limitation, steel. In other exemplary embodiments, however, the body 34 may be formed of material other than metal, such as, for example, various polymeric materials or composite materials, all of which remain within the spirit and scope of the present disclosure.

Additionally, in the exemplary embodiment illustrated in FIGS. 2-4, the body 34 of the mounting base 22 has a polygonal cross-sectional shape, such as, for example, a hexagonal cross-sectional shape. It will be appreciated, however, that the body 34 may have a cross-sectional shape other than a hexagon or polygon, such as, for example and without limitation, circular, oval, triangular, square, and pentagonal shapes, to name a few.

Further, in other exemplary embodiments, rather than having a substantially cylindrical shape having a constant width or diameter along the entire length of the body 34, as is illustrated in FIGS. 2-4, the body 34 may comprise a different shape, such as, for example and without limitation, a substantially conical shape (similar to that illustrated in FIGS. 9A and 10A and described below with respect to another embodiment of the apparatus 10 (i.e., apparatus 110)). Accordingly, the mounting base 22 is not limited to any one particular shape or form.

In an exemplary embodiment, the mounting base 22 further comprises a threaded portion 38 at or in the bottom portion of the body 34 configured for mating with a complementary fastener in order to mount the apparatus 10 onto a suitable mounting surface. More particularly, in an exemplary embodiment such as that illustrated in FIGS. 2 ad 3, the threaded portion 38 comprises a male threaded portion protruding downwardly from the bottom of the body 34 (i.e., the end of the body 34 opposite the end of the body 34 at which the rod 18 is disposed). In such an embodiment, the male threaded portion 38 is configured to be mated with a complementary threaded fastener such as a nut 40 (or a nut 40 and a washer 42). Accordingly, with reference to FIG. 5, to mount the apparatus 10 onto a surface 44, which may be a surface on the truck 14 or the trailer 16 illustrated in FIG. 1, for example, the male threaded portion 38 is inserted into a hole 46 in the surface 44. The nut 40 (with or without the washer 42) is then threaded onto the threaded portion 38 and tightened to form a compression fitting therebetween.

Alternatively, and as illustrated in FIG. 4, in another exemplary embodiment the threaded portion 38 comprises a female threaded portion disposed within the body 34. More particularly, the body 34 comprises a threaded bore 48 in the bottom of the body 34 configured to receive a complementary male threaded fastener such as a bolt (not shown). In such an embodiment, the apparatus 10 is mounted onto the surface 44 by aligning the female threaded portion 38 (i.e., the bore 48) with the hole 46 in the surface 44. A bolt is then inserted through the hole 46 in the surface 44, threaded into the threaded bore 48, and tightened to form a compression fitting therebetween.

Accordingly, embodiments of the apparatus 10 wherein the threaded portion 38 of the mounting base 22 comprises a male or a female threaded portion are both within the spirit and scope of the present disclosure.

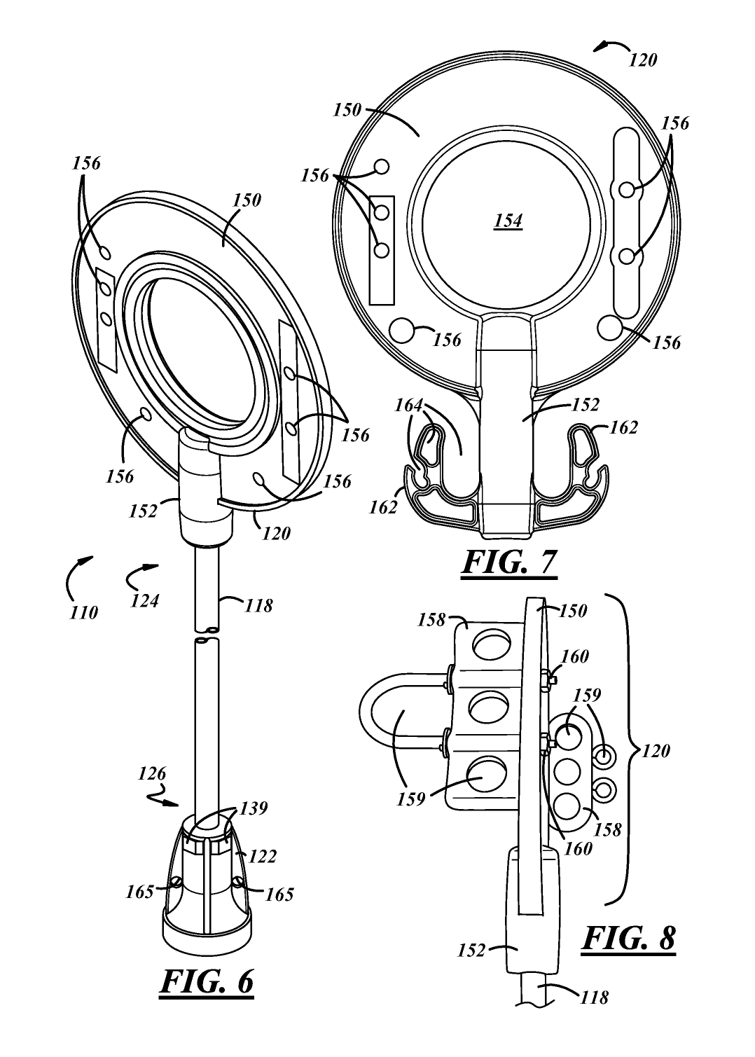

FIG. 6 illustrates another exemplary embodiment of the apparatus 10 (apparatus 110). As with the embodiment of apparatus 10 described above, the apparatus 110 comprises a rod 118, an attachment feature 120, and a mounting base 122. The rod 118 has a first end 124 and a second end 126, and is constructed of a material that renders the rod 118 elastically deformable (i.e., both flexible and resilient). More particularly, the rod 118 is constructed such that when a sufficient force or load (e.g., a lateral force or a force having a lateral component) is applied at or near the first end 124 of the rod 118 by utility lines 112 that, as will be described below, are attached to the rod 118 at or near the first end 124 thereof, the rod 118 will flex/deflect or deform, and then return back to its original state when the force is reduced or removed. For example, and as with the embodiment of the rod 18 described above, in one exemplary embodiment, the rod 118 may begin to flex or deflect upon the application of approximately 10 lbs. of force by the utility lines 112 at or near the first end 124 thereof, and is configured to withstand approximately 35-40 lbs. of force applied thereto. It will be appreciated, however, that the above described embodiment was provided for exemplary purposes only and is not meant to be limiting in nature. Rather, the rod 118 may be constructed such that the amount of force required to flex/deflect or deform the rod 118, and the amount of force that the rod 118 can withstand without yielding, may be greater than or less than that described above. Accordingly, these embodiments of the rod 118 remain within the spirit and scope of the present disclosure.

In an exemplary embodiment, the rod 118 is constructed of, and therefore comprises, a polymeric material, such as, for example and without limitation, a thermoset polyester. It will be appreciated, however, that in other exemplary embodiments, polymeric materials other than a thermoset polyester may be used. Further, in another exemplary embodiment, the rod 118 is constructed of a composite material, such as, for example and without limitation, a thermoset polyester and glass strand composite. It will be appreciated, however, that any number of composites known in the art that will render the rod 118 sufficiently elastically deformable may be used, and therefore, remain within the spirit and scope of the present disclosure. In an exemplary embodiment, all or a portion of the rod 118 may also comprise a photoluminescent material so as to render the rod 118 capable of glowing in the dark. This material may comprise materials that are known in the art, such as, for example and without limitation, glow-in-the-dark concentrates and colorants, that are operative to cause the rod 118 (or portions thereof) to glow-in-dark and to do so in various colors and shades thereof.

In the embodiment illustrated in FIG. 6, the rod 118 has a circular cross-section. However, in other exemplary embodiments, the rod 118 may have a cross-sectional shape other than circular, such as, for example and without limitation oval, square, rectangular, triangular, or other polygonal shapes. Further, the rod 118 may have a constant diameter from the first end 124 to the second end 126 (e.g., on the order of 0.5 inches or 1.27 cm), or alternatively, the diameter may vary from the first end 124 to the second end 126. Yet still further, the rod 118 may have a solid or, in another exemplary embodiment, a hollow construction.

As briefly described above, and as illustrated in FIGS. 6 and 7, the apparatus 110 comprises an attachment feature 120. The attachment feature 120 is configured to attach one or more utility lines 112 (shown in FIG. 1) to the apparatus 110. The attachment feature 120 is disposed, or configured to be disposed, proximate the first end 124 of the rod 118. More particularly, in an exemplary embodiment, the attachment feature 120 is coupled to, or configured to be coupled to, the first end 124 of the rod 118. In such an embodiment, the attachment feature 120 may be coupled to the rod 118 using any number of techniques known in the art, such as, for example and without limitation, those described in greater detail below. Alternatively, rather than coupling the attachment feature 120 with the rod 118, the attachment feature 120 may be integral with the rod 118 at the first end 124 thereof.

In the embodiment illustrated in FIGS. 6-8, the attachment feature 120 comprises a utility line support portion 150 (hereafter also referred to as “support portion 150”) configured to support one or more utility lines 112. In an exemplary embodiment, the attachment feature 120 further comprises a base portion 152 disposed at the bottom of the support portion 150 configured, as will be described below, to be affixed to or coupled with the rod 118 at or near the first end 124 thereof.

As illustrated in FIG. 7, in an exemplary embodiment, the support portion 150 takes the form of a ring having at least a central aperture therein. For purposes of illustration and clarity only, the description below will be limited to an embodiment of the apparatus 110 wherein the support portion 150 of the attachment feature 120 is in the form a ring. It will be appreciated, however, that in other exemplary embodiments, the support portion 150 may take the form of a shape other than a ring, such as, for example and without limitation, an oval, a square, or some other polygonal shape, having one or more apertures, slots, grooves, notches, and other like features therein for accommodating and/or supporting utility lines, all of which remain within the spirit and scope of the present disclosure. Accordingly, the description herein of the support portion 150 taking the form of a ring is provided for exemplary purposes only and is not meant to be limiting in nature.

With continued reference to FIG. 7, in an exemplary embodiment, the support portion 150 of the attachment feature 120 comprises a central aperture 154 (hereafter referred to as “major aperture 154”) configured to accommodate one or more utility lines 112 (or wraps—e.g., 3-in-1, 4-in-1, etc. wraps- containing multiple utility lines 112). In another exemplary embodiment, the support portion 150 may comprise a plurality of apertures, notches, grooves, slots, and other like features therein as opposed to one single major aperture 154. For purposes of illustration and clarity, however, the description below will be limited to an embodiment wherein the support portion 150 comprises the major aperture 154. In addition to the major aperture 154, the support portion 150 may further comprise a plurality of minor apertures 156 therein. Some or all of the minor apertures 156 may be configured to accommodate, for example, one or more utility lines 112. In addition to or instead of the minor apertures 156, in other exemplary embodiments, the support portion 150 may comprises one or more slots, grooves, notches or other like features therein that are configured to accommodate, for example, one or more utility lines. For purposes of illustration and clarity only, the description below will be limited to an embodiment wherein the support portion 150 comprises a plurality of minor apertures 156 therein. However, embodiments wherein the support portion 150 includes features in addition to or other than the apertures 156 remain within the spirit and scope of the present invention.

In an exemplary embodiment, in addition to, or alternatively, one or more of the minor apertures 156 may be configured to accommodate additional apparatus/accessories, such as, for example, one or more clips, clamps, hooks, loops, rings, and other like apparatus, that are, in turn, configured to accommodate and support one or more utility lines 112. For example, and as illustrated in FIG. 8, the attachment feature 120 may further comprise a utility line accommodating apparatus/accessory 158 (hereafter referred to as “clamp 158”) configured to be coupled to the support portion 150 and having one or more features 159, such as, for example and without limitation, apertures (as illustrated in FIG. 8), notches, grooves, slots, channels, eyelets (as illustrated in FIG. 8), and the like, therein to accommodate and support one or more utility lines 112.

In an exemplary embodiment, the clamp 158 is configured to be coupled to the support portion 150 using fasteners. For example, the clamp 158 may comprise one or more threaded portions 160 (male or female) that may be aligned with and, in the instance where the threaded portion 160 is a male threaded portion, inserted into, a corresponding number of minor apertures 156. The threaded portions 160 are then mated with complementary threaded fasteners, such as, for example, a bolt or a nut, depending on whether the threaded portions 160 are female or male threaded portions. It will be appreciated that in other exemplary embodiments, the clamp 158 may be coupled to the support portion 150 using other coupling or affixation means known in the art. Accordingly, the embodiment of the apparatus 110 wherein the clamp 158 is coupled to the support portion 150 using mechanical fasteners is provided for exemplary purposes only and is not meant to be limiting in nature.

As briefly described above, the attachment feature 120 is coupled with, or configured to be coupled with, the first end 124 of the rod 118. In an exemplary embodiment, the base portion 152 of the attachment feature 120 is coupled with, or configured to be coupled with, the first end 124 of the rod 118. The base portion 152 may be coupled with the first end 124 in a number of ways.

For example, the base portion 152 may be molded onto the first end 124 of the rod 118. More particularly, the first end 124 of the rod 118 may be inserted into a mold and then a material, such as, for example and without limitation, a polymeric material (e.g., nylon or glass-filled nylon—e.g., 30% glass-filled nylon), may be introduced into the mold to form the attachment feature 120 (e.g., the support portion 150 and base portion 152). The first end 124 of the rod 118 would be disposed within the mold in such a way that the base portion 152 of the formed attachment feature 120 surrounds the first end 124 so as to couple the attachment feature 120 with the rod 118 when the base portion 152 is cured or hardened.

In another exemplary embodiment, the attachment feature 120 may be coupled to the rod 118 using an adhesive and/or threaded fasteners. For example, the base portion 152 of the attachment feature 120 may comprise a bore (not shown) sized and configured to receive the first end 124 of the rod 118. An adhesive may be applied to the inner surface of the bore and/or to the outer surface of the rod 118 such that when the first end 124 of the rod 118 is inserted into the bore, it becomes affixed thereto.

In yet another exemplary embodiment, the bore may comprise a threaded bore (not shown), and the rod 118 may include a complementary threaded portion (e.g., a male threaded portion) (not shown). The attachment feature 120 may then be threaded onto to the rod 118. In such an embodiment, an adhesive may also be applied to one or both of the outer surface of the rod 118 and the inner surface of the bore to further secure the connection between the components.

In still another exemplary embodiment, the base portion 152 of the attachment feature 120 may include a male threaded portion (not shown), and the first end 124 of the rod 118 may include a female threaded portion (not shown) therein. The attachment feature 120 may then be threaded into the female threaded portion of the rod 118. In such an embodiment, an adhesive may also be applied to one or both of the outer surface of the rod 118 and the inner surface of the bore to further secure the connection between the components.

Accordingly, the attachment feature 120 may be coupled with the rod 118 using any number of techniques known in the art, all of which remain within the spirit and scope of the present invention.

As illustrated in FIG. 7, in an exemplary embodiment, the attachment feature 120 may further comprise one or more arms 162 extending outwardly from one or both of the support portion 150 and the base portion 152 of the attachment feature 120. For purposes of illustration and ease of description purposes only, the description below will be limited to the embodiment illustrated in FIG. 7 wherein the attachment feature 120 comprises two arms 162. It will be appreciated, however, that in other exemplary embodiments, the attachment feature 120 may comprise more or less than two arms, and as such, those embodiments remain within the spirit and scope of the present disclosure.

The arms 162 are configured to accommodate one or more utility lines 112 and/or other apparatus or accessories that require support or storage, such as, for example and without limitation, tarp straps used with the trailer. The arms 162 are also particularly useful when the truck 116 does not have a trailer attached thereto, and therefore, the utility lines 112 have no connection on the trailer side of the lines 112. In such an instance, the utility lines 112 can be hung on the arms 162 to aid in the support and protection of the utility lines 112. As illustrated in FIG. 7, the arms 162 comprise a plurality of features 164, such as, for example and without limitation, notches, grooves, recesses, apertures, hooks, slots, and the like, that may be used to support the utility lines 112 and other apparatus/accessories.

The arms 162 may be affixed to or coupled with either the support portion 150 or the base portion 152 (as is illustrated in FIG. 7) in a number of ways. For example, the arms 162 may be integral with one or both of portions 150, 152 of the attachment feature 120 (e.g., the arms may be formed when the feature 120 is molded, as described above). Alternatively, the arms 162 may be separate and distinct components that are affixed to attachment feature 120 using, for example, an adhesive, mechanical fasteners, or other known techniques.

In addition to the arms 162, the mounting feature 120 may further include one or more holes or apertures 165 disposed within the rod 118 proximate the second end 126 thereof, or in the mounting base 122 (as shown in FIG. 6, for example), that are configured to allow apparatus/accessories to be coupled between the arms 162 and the holes/apertures for storage purposes.

With reference to FIGS. 9A-10B, and as briefly described above, in addition to the rod 118 and the attachment feature 120, the apparatus 110 further comprises a mounting base 122. The mounting base 122 is configured for mounting the apparatus 110 to a surface, such as, for example, an appropriate mounting surface on a truck or a trailer (See FIG. 1). The mounting base 122 is disposed, or configured to be disposed, at the second end 126 of the rod 118. More particularly, in an exemplary embodiment, the mounting base 122 is coupled with, or configured to be coupled with, the second end 126 of the rod 118 using a number of techniques known in the art, some of which will be described in greater detail below. Alternatively, rather than coupling the mounting base 122 with the rod 118, the mounting base 122 may be integral with the rod 118 at the second end 126 thereof.

The mounting base 122 has a body 134 that, in an exemplary embodiment, has a substantially conical shape that tapers from the bottom to the top of the mounting base 122. As illustrated in FIGS. 9A and 10A, in an exemplary embodiment, body 134 comprises a plurality of flanges 166 equally spaced about the circumference of the body 134. The flanges 166 extend from the bottom to the top of the body 134 and together give the body 134 a substantially conical shape.

It will be appreciated that while the mounting base 122, and the body 134 thereof, in particular, is described herein as having a substantially conical shape, in other exemplary embodiments the body 134 may take any number of forms or shapes, all of which remain within the spirit and scope of the present disclosure. For example, the body 134 may comprise an elongate body having a circular, polygonal, or some other cross-sectional shape (See, for example, FIGS. 2-4 and the description above relating to another embodiment of the apparatus 110 (i.e., apparatus 10)). In another exemplary embodiment, the body 134 may have a first portion at the bottom thereof having a first diameter and a second portion integral with the first portion and disposed at the top of the body 134 having a significantly different diameter than the first portion. Accordingly, the embodiment wherein the body 134 has a substantially conical shape is provided for exemplary purposes only and is not meant to be limiting in nature.

As illustrated in FIG. 6, the mounting base 122, which may be formed of a metallic material, a polymeric material (e.g., nylon or glass-gilled nylon—e.g., 30% glass-filled nylon), or a composite material, may be coupled with, or configured to be coupled with, the second end 126 of the rod 118. The mounting base 122 may be coupled with the second end 126 of the rod 118 in a number of ways.

In an exemplary embodiment, mounting base 122 may be molded onto the second end 126 of the rod 118. More particularly, the second end 126 of the rod 118 may be inserted into a mold and then a material, such as, for example and without limitation, a polymeric material (e.g., nylon or glass-filled nylon), may be introduced into the mold to form the mounting base 122. The second end 126 of the rod 118 would be disposed within the mold in such a way that the mounting base 122 surrounds the second end 126 so as to couple the mounting base 122 with the rod 118 when the mounting base 122 is cured or hardened.

In another exemplary embodiment, the mounting base 122 may be coupled to the rod 118 using an adhesive and/or threaded fasteners. For example, and as illustrated in FIGS. 9B and 10B, the body 134 of the mounting base 122 may comprise a bore 136 in the top portion thereof sized and configured to receive the second end 126 of the rod 118. An adhesive may be applied to the inner surface of the bore 136 and/or to the outer surface of the rod 118 such that when the second end 126 of the rod 118 is inserted into the bore 134, it becomes affixed thereto.

In still another exemplary embodiment, the bore 136 may comprise a threaded bore (not shown) and the rod 118 may include a complementary threaded portion (e.g., a male threaded portion) (not shown). In such an embodiment, the mounting base 122 may be threaded onto the rod 118. An adhesive may also be applied to one or both of the outer surface of the threaded portion of the rod and the inner surface of the bore to further secure the connection between the components.

In yet another exemplary embodiment, the top of the mounting base 122 may include a male threaded portion (not shown), and the second end 126 of the rod 118 may include a female threaded portion (not shown) therein. In such an embodiment, the mounting base 122 may be threaded into the female threaded portion of the rod 118. An adhesive may also be applied to one or both of the outer surface of the threaded portion of the rod and the inner surface of the bore to further secure the connection between the components.

Accordingly, the mounting base 122 may be coupled with the rod 118 using any number of techniques known in the art, all of which remain within the spirit and scope of the present invention.

With continued reference to FIGS. 9B and 10B, in an exemplary embodiment, the mounting base 122 further comprises a threaded portion 138 at or in the bottom portion of the body 134 configured for mating with a complementary fastener. More particularly, in an exemplary embodiment, such as that illustrated in FIGS. 9A and 9B, the threaded portion 138 of the mounting base 122 comprises a male threaded portion protruding downwardly from the bottom of the body 134 (i.e., the end of the body 134 opposite the end of the body 134 at which the rod 118 is disposed). In such an embodiment, the male threaded portion 138 is configured to be mated with a complementary threaded fastener such as a nut (or a nut and a washer). Accordingly, to mount the apparatus 110 onto a surface, which may be a surface on a truck or a trailer (See FIG. 1), the male threaded portion 138 is inserted into a hole in the surface. A nut (with or without a washer) is then threaded onto the threaded portion 138 and tightened to form a compression fitting therebetween. In an exemplary embodiment, and as illustrated in FIG. 9A, the top of the mounting base 122 may further comprise a plurality of flat portions 139. The flat portions 139 are configured to accommodate a wrench to allow for the holding of the mounting base 122 when the nut is tightened during the mounting of the apparatus 110 onto the surface.

Alternatively, and as illustrated in FIG. 10B, in another exemplary embodiment, the threaded portion 138 of the mounting base 122 comprises a female threaded portion disposed within the body 134. More particularly, in an exemplary embodiment such as that illustrated in FIGS. 10A and 10B, the body 134 comprises a threaded bore 148 in the bottom thereof configured to receive a complementary male threaded fastener such as a bolt. In this embodiment, to mount the apparatus 110 onto a surface, the female threaded portion 138 (i.e., the bore 148) is aligned with a hole in the surface. A bolt is then inserted through the hole in the surface and threaded into the threaded bore 148 and tightened to form a compression fitting therebetween. As described above, in an exemplary embodiment, and as illustrated in FIG. 10A, the top of the mounting base 122 may further comprise a plurality of flat portions 139. The flat portions 139 are configured to accommodate a wrench to allow for the holding of the mounting base 122 when the bolt is tightened during the mounting of the apparatus 110 onto the surface.

Accordingly, embodiments of the apparatus 110 wherein the mounting base 122 has a male or a female threaded portion 138 are both within the spirit and scope of the present disclosure.

In an embodiment wherein the mounting base 122, and the body 134 thereof, in particular, is molded, the threaded portion 138 may comprise an insert, such as, for example and without limitation, a metallic (e.g., steel) insert, that is molded into the body 134 when the body 134 is formed. More particularly, an insert comprising either a male or female threaded portion may be placed in a mold and then and then a material, such as, for example and without limitation, a polymeric material (e.g., nylon or glass-filled nylon), may be introduced into the mold to form the body 134. The insert would be disposed within the mold in such a way that the body 134 surrounds the insert so as to create the threaded portion 138 of the mounting base 122. In an exemplary embodiment, the above described process may be performed at the same time as the mounting base 122 is molded onto the second end 126 of the rod 118. Alternatively, it may be a separate process.

FIG. 11 illustrates another exemplary embodiment of the apparatus 10 (apparatus 210). In this embodiment, the apparatus 210 comprises a first portion 268, a second portion 270, an attachment feature 220, and a mounting feature 272. The first portion 268 comprises an elongate shaft 274 having a first end 276 and a second end 278. The second portion 270 is integral with the first portion 268 at the second end 278 thereof, and comprises a spring 280. As used herein with respect to this particular embodiment, the phrase “integral” is intended to mean formed of a common or single piece of material, as opposed to two or more components being coupled or affixed together. Accordingly, the first and second portions 268, 270 of the apparatus 210 are formed of a common, or the same, piece of material wherein one portion of the piece (i.e., the first portion 268) is formed into a shaft, and a second portion (i.e., the second portion 270) is formed into a spring, such as, for example, a coil spring 280.

In an exemplary embodiment, the apparatus 210, and the first and second portions 268, 270 thereof, in particular, comprise a metallic material. More particularly, in an exemplary embodiment, the first and second portions 268, 270 comprise spring steel. However, it will be appreciated that in other exemplary embodiments, suitable metallic materials known in the art other than spring steel may be used, and therefore, remain within the spirit and scope of the present disclosure. Additionally, in order to prevent corrosion of the metallic material, in an exemplary embodiment, at least portions of the first and second portions 268, 270 are anodized or coated with a corrosion-resistant coating such as, for example and without limitation, paint, powder coating, and any other of a number of known metal coating technologies.

In one exemplary embodiment, the shaft 274 of the first portion 268, and the windings of the spring 280 of the second portion 270, both have a circular cross-section and a constant diameter. In one embodiment provided for exemplary purposes only, the magnitude of the diameter of both the shaft 274 and the wire forming the windings of the spring 280 is 0.465 inches (11.8 mm). However, it will be appreciated that in other exemplary embodiments, the diameter of one or both of the shaft 274 and the wire forming windings of the spring 280 may be more or less than that described above. Additionally, in other exemplary embodiments, one or both of the shaft 274 and the wire forming windings of the spring 280 may have a cross-sectional shape other than circular, may have varying diameters throughout their respective lengths. Accordingly, these embodiments remain within the spirit and scope of the present disclosure.

As described above, the second portion 270 of the apparatus 210 comprises a spring 280. In an exemplary embodiment, the spring 280 comprises a coil spring having a plurality of windings. Accordingly, the piece of material used to form the apparatus 210 is wound a predetermined number of times to create a coil spring 280. In one embodiment provided for exemplary purposes only, the spring 280 has seven (7) windings. However, the number of windings the spring 280 has is dependent upon a number of factors, such as, for example and without limitation, the type and diameter of the material used to construct the windings, the length of the shaft 274, the desired threshold magnitude of the force or load at which the apparatus 210 begins to flex/deflect, the maximum force or load that the apparatus 210 must be able to withstand without yielding, and the like. Accordingly, the present disclosure is not limited to a spring having a particular number of windings, but rather embodiments of the apparatus 210 wherein the spring 280 thereof has more or less than the number of windings set forth herein remain within the spirit and scope of the present disclosure.

The individual windings of the coil spring 280 may each have a common diameter, or may have different diameters. In one embodiment provided for exemplary purposes only, the inner diameters are equal and may have a magnitude on the order of two (2) inches (5 cm). Similarly, the pitch between each winding and the windings adjacent thereto may be equal or may differ. In one embodiment provided for exemplary purposes only, the pitch between each winding and the windings adjacent thereto are equal, and have a magnitude on the order of 1.75 inches (4.44 cm). However, it will be appreciated that in other exemplary embodiments, the diameters of the windings and the pitch between each winding and the adjacent windings may be more or less than those dimensions described above. These embodiments remain within the spirit and scope of the present disclosure.

As with the elastically deformable rod 18/118 described above, the purpose of the spring 280 is to allow the apparatus 210 to be both flexible and resilient. More particularly, when a sufficient amount of force (e.g., a lateral force or a force that has a lateral component to it) is applied at or near the first end 276 of the shaft 274 by utility lines 212 that, as will be described below, are attached to the shaft 274 at or near the first end 276 thereof, the spring 280 will flex/deflect and then return back to its original state when the force is reduced or removed. For example, in one embodiment provided for exemplary purposes only, the spring 280 may begin to flex or deflect upon the application of approximately 10 lbs. of force by the utility lines 12 at or near the first end 276 thereof, and is configured to withstand an applied force in excess of 35-40 lbs. It will be appreciated, however, that the above described embodiment was provided for exemplary purposes only and is not meant to be limiting in nature. Rather, the spring 280 may be constructed such that the amount of force required to flex/deflect the spring 280, and the amount of force the spring 280 may withstand without yielding, may be greater than or less than that described above. Accordingly, these embodiments of the spring 280 remain within the spirit and scope of the present disclosure.

As briefly described above, the apparatus 210 also comprises an attachment feature 220. The attachment feature 220 is disposed, or configured to be disposed, proximate the first end 276 of the shaft 274, and is configured to accommodate and support utility lines 212 extending, for example, between a truck and a trailer.

In the exemplary embodiment illustrated in FIG. 11, the attachment feature 220 is integral with the shaft 274. In other words, the attachment feature 220 is formed or constructed from the same piece of material used to construct or form the shaft 274 and the spring 280. In such an embodiment, the attachment feature 220 may comprise a loop, a ring, or some other shaped feature configured to accommodate and support one or more utility lines 212 or other apparatus/accessories used to attach the utility lines 212 to the apparatus 210, such as, for example, clips, clamps, hooks, rings, and other like apparatus.

In another exemplary embodiment, the attachment feature 220 is not integral with the shaft 274, but rather is a separate and distinct component that is configured to be coupled with or affixed to the shaft 274 of the apparatus 210. In such an embodiment, the attachment feature 220, which may take the same or similar form of any of attachment members 22 and 122 described above, for example, may be coupled with or affixed to the shaft 274 using coupling/affixation techniques well known in the art, such as, for example and without limitation, welding, brazing, adhesives, clamping, and the like. In one exemplary embodiment, the shaft 274 may have one or more holes therein configured to receive a portion of the mounting feature 220 therein (e.g., a portion of a clip that is inserted into the hole(s)), or to allow for the coupling of the mounting feature 220 thereto by way of mechanical fasteners (e.g., a bolt or a threaded portion of the mounting feature 220 is inserted into the holes and mated with a complementary threaded nut). Accordingly, the present disclosure is not limited to any one particular type of mounting feature, but rather any number of mounting features known in the art may be used and remain within the spirit and scope of the present disclosure.

With continued reference to FIG. 11, and as briefly described above, the apparatus 210 further comprises a mounting feature 272. The mounting feature 272 is associated with the second portion 270 of the apparatus 210, and is configured for mounting the apparatus 210 to a surface, such as, for example, an appropriate mounting surface on a truck or a trailer. In an exemplary embodiment, the mounting feature comprises a threaded portion 282 that is configured to mate with a complementary threaded fastener.

For example, in one exemplary embodiment, the second portion 270 of the apparatus 210 includes an elongate member 284 extending downward in an axial direction relative to the longitudinal axis of the shaft 274 from the end of the spring 280 opposite the end where the first and second portions 268, 270 interface. In such an embodiment, the elongate member 284 is threaded and comprises the threaded portion 282 of the mounting feature 272. As with the embodiments described above, to mount the apparatus 210 onto a surface, the threaded elongate member 284 is inserted into a hole in the surface. A nut (with or without a washer) is then threaded onto the elongate threaded member 284 and tightened to form a compression fitting therebetween.

Alternatively, in another exemplary embodiment the elongate member 284 is not threaded, but rather comprises a threaded bore (not shown) therein configured to receive a complementary male threaded fastener such as a bolt. Accordingly, to mount the apparatus 210 onto a surface, the elongate member 284 is aligned with the hole in the surface, and a bolt is then inserted through the hole in the surface and threaded into the female threaded bore and tightened to form a compression fitting therebetween. Accordingly, embodiments of the apparatus 210 wherein the threaded portion 280 of the mounting feature 272 comprises a male or a female threaded portion both are within the spirit and scope of the present disclosure.

In another exemplary embodiment, the mounting feature 272 may comprise a mounting plate (not shown) that is coupled with or affixed to the second portion 270 of the apparatus 210 using any number of techniques known in the art, such as, for example, welding, brazing, and the like. The mounting plate may then, in turn, be coupled with or affixed to a suitable mounting surface using, for example, mechanical fasteners.

Although only certain embodiments have been described above with a certain degree of particularity, those skilled in the art could make numerous alterations to the disclosed embodiments without departing from the scope of this disclosure. Additionally, any and all directional references (e.g., top, bottom, up, down, left, right) are only used for identification purposes to aid the reader's understanding of the present invention, and do not create limitations, particularly as to the position, orientation, or use of the invention. Joinder references (e.g., attached, affixed, coupled, connected, and the like) are to be construed broadly and may include intermediate members between a connection of elements and relative movement between elements. As such, joinder references do not necessarily infer that two elements are directly connected/coupled and in fixed relation to each other. It is intended that all matter contained in the above description or shown in the accompanying drawings shall be interpreted as illustrative only and not limiting. Changes in detail or structure may be made without departing from the invention as defined in the appended claims.

1. An apparatus for supporting one or more utility lines extending between a vehicle and a trailer, the apparatus comprising:
an elastically deformable rod having a first end and a second end;
an attachment feature disposed proximate said first end of said rod and configured to attach at least one utility line to said apparatus; and
a mounting base disposed at said second end of said rod configured for mounting said apparatus to a surface.

2. The apparatus of claim 1, wherein said rod comprises a polymeric material.

3. The apparatus of claim 1, wherein said attachment feature comprises a base portion and a utility line support portion, and further wherein said base portion is coupled to said first end of said rod.

4. The apparatus of claim 3, wherein said support portion comprises at least one aperture therein.

5. The apparatus of claim 4, wherein said support portion comprises a major aperture and a plurality of minor apertures therein.

6. The apparatus of claim 3, wherein said attachment feature further comprises a utility line accommodating apparatus configured to be coupled to said support portion and further configured to accommodate and support at least one utility line.

7. The apparatus of claim 3, wherein said attachment feature further comprises at least one arm extending outwardly from one of said base portion and said support portion, and further wherein said at least one arm is configured to support at least one utility line.

8. The apparatus of claim 1, wherein said attachment feature comprises an eye-bolt coupled with said rod.

9. The apparatus of claim 1, wherein at least a portion of said rod comprises a photoluminescent material.

10. The apparatus of claim 1, wherein said mounting base comprises a threaded portion configured for mating with a complementary fastener.

11. An apparatus for supporting one or more utility lines extending between a vehicle and a trailer, the apparatus comprising:
an elastically deformable rod having a first end and a second end;
an attachment feature configured to be coupled with said rod proximate said first end thereof and further configured to attach at least one utility line to said apparatus;
a mounting base configured to be coupled with said rod at said second end thereof and further configured for mounting said apparatus to a surface.

12. The apparatus of claim 11, wherein said rod comprises a polymeric material.

13. The apparatus of claim 1, wherein said attachment feature comprises a base portion and a support portion, and further wherein said base portion is configured to be coupled to said first end of said rod.

14. The apparatus of claim 1, wherein said attachment feature comprises an eye-bolt configured to be coupled to said rod.

15. The apparatus of claim 1, wherein said mounting base comprises a threaded portion configured for mating with a complementary fastener.

16. An apparatus for supporting one or more utility lines extending between a vehicle and a trailer, the apparatus comprising:
a first portion comprising an elongate shaft having a first end and a second end;
a second portion integral with said first portion and comprising a spring;
an attachment feature configured to be disposed proximate said first end of said shaft and further configured to attach at least one utility line to said apparatus; and
a mounting feature associated with said second portion configured for mounting said apparatus to a surface.

17. The apparatus of claim 16, wherein said attachment feature is integral with said shaft.

18. The apparatus of claim 16, wherein said first and second portions comprise a metallic material.

19. The apparatus of claim 16, wherein said mounting feature comprises a threaded portion configured for mating with a complementary threaded fastener.

20. The apparatus of claim 19, wherein said mounting feature comprises an elongate member extending downwardly from said spring and having a threaded portion, and wherein said threaded portion of said elongate member comprises said threaded portion of said mounting feature.
